(19) United States
(12) Patent Application Publication
(10) Pub. No.: US 2024/0348472 A1
(43) Pub. Date: Oct. 17, 2024

(54) RELAY DEVICE, RELAY SYSTEM, RELAY METHOD, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Hitoshi KONO, Yokkaichi-shi, Mie (JP); Hideki Maeda, Yokkaichi-shi, Mie (JP); Takeshi Hagihara, Yokkaichi-shi, Mie (JP); Ryo Yamane, Osaka-shi, Osaka (JP); Tatsuya Izumi, Osaka-shi, Osaka (JP); Hideyuki Tanaka, Osaka-shi, Osaka (JP)

(21) Appl. No.: 18/294,253

(22) PCT Filed: Jun. 27, 2022
(86) PCT No.: PCT/JP2022/025539

§ 371 Date: Feb. 1, 2024

(30) Foreign Application Priority Data
Aug. 4, 2021 (JP) 2021-128229

(51) Int. Cl. H04L 12/40; H04L 65/75

(52) U.S. Cl. CPC H04L 12/40; H04L 65/75; H04L 2012/40273

(57) ABSTRACT

A relay device includes: an upper port configured to receive an upper packet containing audio data of a plurality of channels; a plurality of lower ports configured to output lower packets containing audio data of one or a plurality of channels; and a generation unit configured to reconstruct the upper packet to generate the lower packets. The plurality of lower ports include a first lower port and a second lower port. The first lower port is a starting point of a first network. The second lower port is a starting point of a second network and does not share nodes with the first network. The generation unit deletes audio data of a channel to be reproduced in the second network from the audio data contained in the upper packet, to construct audio data to be contained in the lower packet to be outputted from the first lower port.

### CROSS-REFERENCE TO RELATED APPLICATIONS

This application is the U.S. national stage of PCT/JP2022/025539, filed Jun. 27, 2022, which claims priority of JP 2021-128229, filed Aug. 4, 2021, the contents of which are incorporated herein.

### TECHNICAL FIELD

The present disclosure relates to a relay device, a relay system, a relay method, and a computer program.

### BACKGROUND

Conventionally, a surrounding audio system including a plurality of speakers arranged so as to surround a user, has been known. For example, in a 5.1 ch surround system, five speakers and one subwoofer are installed. Surround audio data is transmitted from an input device such as a CD player to these speakers.

In this case, a technique of connecting the input device to an output device such as a speaker by a cable conforming to the Ethernet (registered trademark) standard, and transmitting the data according to the Ethernet AVB (Audio Video Bridging) standard, has been known. The Ethernet AVB is a set of standards for transmitting video data and audio data by using the Ethernet.

For example, Japanese Laid-Open Patent Publication No. 2017-204857 discloses a configuration of a vehicle network in which a plurality of end nodes (e.g., ECUs: electronic control units) included in a vehicle are connected to each other via switches by using the Ethernet AVB. In transmitting data from a first end node (talker) to a second end node (listener), communication for reserving a band required for the data transmission is performed in advance. Specifically, an advertising frame including information such as the maximum size of the data to be transmitted is transmitted from the first end node to the second end node. Upon receiving the advertising frame, the second end node generates a ready frame and transmits the ready frame to the first end node.

In the case where audio data of a plurality of channels are transmitted from an input device to a plurality of output devices by using the Ethernet as in the surround system, it is necessary to synchronize reproduction timings of the audio data in the plurality of output devices. IEEE1722 (“IEEE” is a registered trademark) is a standard for synchronizing data outputs in a plurality of output devices. The IEEE1722 is one of the standards included in the Ethernet AVB.

Therefore, when the audio data of a plurality of channels are transmitted from the input device to the plurality of output devices according to the IEEE1722, a bandwidth capable of transmitting the audio data needs to be ensured in all the links from the input device to the respective output devices. If the bandwidth capable of transmitting the audio data of a plurality of channels is not ensured, loss of audio data or other packets may occur due to band shortage. However, since high-priority data (e.g., data for controlling vehicle traveling) is also transferred together with the audio data in the in-vehicle network, there is a possibility that a bandwidth for transmitting the audio data of a plurality of channels cannot be ensured in the in-vehicle network. Moreover, there is a tendency that the more the in-vehicle network has branches, the smaller the bandwidth that output devices located at the ends of the branches can have. Therefore, such output terminals cannot ensure the bandwidth required by the IEEE1722.

### SUMMARY

In view of the above problems, an object of the present disclosure is to provide a relay device, a relay system, a relay method, and a computer program capable of more reliably transmitting audio data of a plurality of channels in an in-vehicle network.

A relay device according to the present disclosure is a relay device that relays a packet containing audio data from an upper side to a lower side of an in-vehicle network. The relay device includes: an upper port configured to receive an upper packet containing audio data of a plurality of channels: a plurality of lower ports configured to output lower packets containing audio data of one or a plurality of channels; and a generation unit configured to reconstruct the upper packet to generate the lower packets. The plurality of lower ports include a first lower port and a second lower port. The first lower port is a starting point of a first network that is located below the relay device. The second lower port is a starting point of a second network that is located below the relay device and does not share nodes with the first network. The generation unit deletes audio data of a channel to be reproduced in the second network from the audio data contained in the upper packet, to construct audio data to be contained in the lower packet to be outputted from the first lower port.

A relay method according to the present disclosure is a relay method for a relay device to relay a packet containing audio data from an upper side to a lower side of an in-vehicle network. The relay device includes: an upper port configured to receive an upper packet containing audio data of a plurality of channels; and a plurality of lower ports configured to output lower packets containing audio data of one or a plurality of channels. The plurality of lower ports include a first lower port and a second lower port. The first lower port is a starting point of a first network that is located below the relay device. The second lower port is a starting point of a second network that is located below the relay device and does not share nodes with the first network. The relay method includes a generation step of generating the lower packet by reconstructing the upper packet. The generation step includes deleting audio data of a channel to be reproduced in the second network from the audio data contained in the upper packet, to construct audio data to be contained in the lower packet to be outputted from the first lower port.

A computer program according to the present disclosure is a computer program for a relay device to relay a packet containing audio data from an upper side to a lower side of an in-vehicle network. The relay device includes: an upper port configured to receive an upper packet containing audio data of a plurality of channels; and a plurality of lower ports configured to output lower packets containing audio data of one or a plurality of channels. The plurality of lower ports include a first lower port and a second lower port. The first lower port is a starting point of a first network that is located below the relay device. The second lower port is a starting point of a second network that is located below the relay device and does not share nodes with the first network. The computer program causes a computer to execute a generation step of generating the lower packet by reconstructing the upper packet. The generation step includes deleting audio data of a channel to be reproduced in the second network from audio data contained in the upper packet, to construct audio data to be contained in the lower packet to be outputted from the first lower port.

### Advantageous Effects

According to the present disclosure, audio data of a plurality of channels can be more reliably transmitted in an in-vehicle network.

### BRIEF DESCRIPTION OF DRAWINGS

FIG. 1 is a block diagram showing an entire configuration of a relay system according to an embodiment of the present disclosure.

FIG. 2 is a schematic diagram illustrating an example of arrangement of a plurality of first output devices according to the embodiment.

FIG. 3 is a block diagram schematically showing a functional configuration of a relay device according to the embodiment.

FIG. 4 shows an example of a packet configuration according to the embodiment.

FIG. 5 shows an example of the content of data according to the embodiment.

FIG. 6 shows data for ports constructed by a construction unit according to the embodiment.

FIG. 7 is a sequential diagram showing an example of a relay method according to the embodiment.

FIG. 8 is a diagram illustrating a subject of the present disclosure.

### DETAILED DESCRIPTION OF PREFERRED EMBODIMENTS

An embodiment of the present disclosure includes the following configurations as main points.

A elay device according to the present disclosure is a relay device that relays a packet containing audio data from an upper side to a lower side of an in-vehicle network. The relay device includes: an upper port configured to receive an upper packet containing audio data of a plurality of channels: a plurality of lower ports configured to output lower packets containing audio data of one or a plurality of channels; and a generation unit configured to reconstruct the upper packet to generate the lower packets. The plurality of lower ports include a first lower port and a second lower port. The first lower port is a starting point of a first network that is located below the relay device. The second lower port is a starting point of a second network that is located below the relay device and does not share nodes with the first network. The generation unit deletes audio data of a channel to be reproduced in the second network from the audio data contained in the upper packet, to construct audio data to be contained in the lower packet to be outputted from the first lower port.

The lower packet generated by the generation unit does not contain audio data of a channel to be reproduced by a node that is not present in the first network located below the first lower port, and therefore, the lower packet has a data amount smaller than that of the upper packet. Therefore, the bandwidth required for transmitting the lower packet from the relay device to the lower side is smaller than the bandwidth required for transmitting the upper packet as it is to the lower side. As a result, the bandwidth for packet transmission can be easily ensured, whereby audio data including a plurality of channels can be more reliably transmitted.

Preferably, the generation unit deletes, from the audio data contained in the upper packet, audio data of a channel to be outputted in the first network, to construct audio data to be contained in the lower packet to be outputted from the second lower port.

The generation unit generates the lower packet to be outputted from the first lower port, and also generates the lower packet to be outputted from the second lower port. Thus, in each of the first network and the second network located below the relay device, the bandwidth required for packet transmission can be reduced, whereby audio data including a plurality of channels can be more reliably transmitted.

Preferably, the relay device further includes: a relay unit configured to relay a connection packet to be transmitted from a lower-side node to an upper-side node before the upper packet is inputted to the upper port; and an acquisition unit configured to, based on the connection packet, acquire channel information regarding a channel to be reproduced in at least one of the first network and the second network. The connection packet is a packet for the upper-side node to collect information regarding the lower-side node, and the generation unit generates the lower packet, based on the channel information.

The connection packet is a packet that is transmitted for establishing connection between the upper-side node and the lower-side node. Since the relay device grasps a channel to be reproduced (a channel to be left or a channel to be deleted) in the first network or the second network, based on such an existing packet, it is not necessary to increase excessive packets. That is, the audio data including a plurality of channels can be more reliably transmitted while preventing the burden of packet transmission/reception from increasing.

Preferably, the connection packet includes: a packet conforming to an AVDECC connection management protocol in IEEE1722.1; and a packet conforming to an AVDECC enumeration and control protocol in IEEE1722.1.

These packets allow the relay device to easily grasp the connection state between the relay device and each lower-side node, and channel numbers corresponding to respective lower-side nodes.

Preferably, the relay device further includes a filter unit configured to output the connection packet inputted from the lower port, to the relay unit and the acquisition unit, and output the upper packet inputted from the upper port, to the generation unit.

Preferably, the filter unit outputs, to the relay unit, a packet other than the upper packet and the connection packet.

With the above configuration, the relay device has the function of reconstructing the upper packet containing the audio data of a plurality of channels to the lower packet, and can relay the other packet as it is. Therefore, the relay device can be more preferably used in an in-vehicle network in which audio data and other data coexist.

Preferably, data detected by an in-vehicle sensor device is contained in the packet other than the upper packet and the connection packet.

With the above configuration, the relay device has the function of reconstructing the upper packet containing the audio data of a plurality of channels to the lower packet, and can relay data detected by the in-vehicle sensor device as it is. Therefore, the relay device can be more preferably used in an in-vehicle network in which audio data and data related to the vehicle coexist.

A relay system according to the present disclosure includes: the relay device; an upper-side node configured to output the upper packet; and a lower-side node configured to reproduce the audio data contained in the lower packet.

A relay method according to the present disclosure is a relay method for a relay device to relay a packet containing audio data from an upper side to a lower side of an in-vehicle network. The relay device includes: an upper port configured to receive an upper packet containing audio data of a plurality of channels; and a plurality of lower ports configured to output lower packets containing audio data of one or a plurality of channels. The plurality of lower ports include a first lower port and a second lower port. The first lower port is a starting point of a first network that is located below the relay device. The second lower port is a starting point of a second network that is located below the relay device and does not share nodes with the first network. The relay method includes a generation step of generating the lower packet by reconstructing the upper packet. The generation step includes deleting audio data of a channel to be reproduced in the second network from the audio data contained in the upper packet, to construct audio data to be contained in the lower packet to be outputted from the first lower port.

The lower packet generated in the generation step does not contain audio data of a channel to be reproduced by a node that is not present in the first network located below the first lower port, and therefore, the lower packet has a data amount smaller than that of the upper packet. Therefore, the bandwidth required for transmitting the lower packet from the relay device to the lower side is smaller than the bandwidth required for transmitting the upper packet as it is to the lower side. As a result, the bandwidth for packet transmission can be easily ensured, whereby audio data including a plurality of channels can be more reliably transmitted.

A computer program according to the present disclosure is a computer program for a relay device to relay a packet containing audio data from an upper side to a lower side of an in-vehicle network. The relay device includes: an upper port configured to receive an upper packet containing audio data of a plurality of channels; and a plurality of lower ports configured to output lower packets containing audio data of one or a plurality of channels. The plurality of lower ports include a first lower port and a second lower port. The first lower port is a starting point of a first network that is located below the relay device. The second lower port is a starting point of a second network that is located below the relay device and does not share nodes with the first network. The computer program causes a computer to execute a generation step of generating the lower packet by reconstructing the upper packet. The generation step includes deleting audio data of a channel to be reproduced in the second network from audio data contained in the upper packet, to construct audio data to be contained in the lower packet to be outputted from the first lower port.

The lower packet generated in the generation step does not contain audio data of a channel to be reproduced by a node that is not present in the first network located below the first lower port, and therefore, the lower packet has a data amount smaller than that of the upper packet. Therefore, the bandwidth required for transmitting the lower packet from the relay device to the lower side is smaller than the bandwidth required for transmitting the upper packet as it is to the lower side. As a result, the bandwidth for packet transmission can be easily ensured, whereby audio data including a plurality of channels can be more reliably transmitted.

Hereinafter, details of the embodiment of the present disclosure will be described with reference to the drawings.

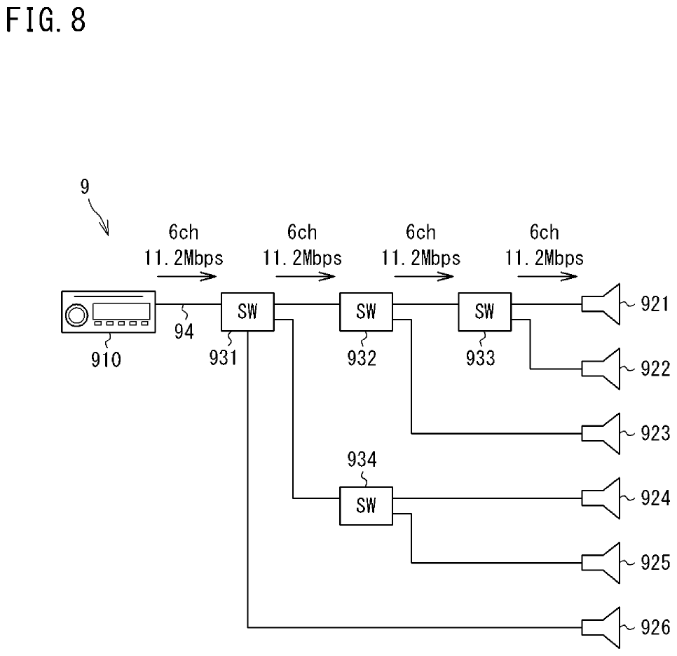

FIG. 8 illustrates a subject of the present disclosure. A relay system 9 includes an input device 910, a plurality of output devices 921 to 926, and a plurality of relay devices 931 to 934 connected between the input device 910 and the respective output devices 921 to 926. The relay system 9 is a system in which surround audio data is transmitted from the input device 910 to the plurality of output devices 921 to 926 via the relay devices 931 to 934. The input device 910, the output devices 921 to 926, and the relay devices 931 to 934 are connected to each other by an Ethernet compatible communication line 94.

As for the surround audio data to be transmitted from the input device 910 to the relay device 931 via the communication line 94, audio data of a plurality of (6 in the example of FIG. 8) channels corresponding to all the output devices 921 to 926 are contained in one packet. In the conventional communication method, this packet is transmitted to the plurality of output devices 921 to 926 with the number of channels as they are.

That is, when the audio data of 6 channels have been transmitted from the input device 910 to the relay device 931, the audio data of 6 channels are also transmitted from the relay device 931 to the relay devices 932, 934, and from the relay device 932 to the relay device 933. Then, each of the output devices 921 to 926 selects one channel to be reproduced, from among the received audio data of 6 channels, and reproduces the audio data of the selected channel.

Therefore, for example, if a bandwidth of 11.2 Mbps is required between the input device 910 and the relay device 931 in order to transmit the audio data of 6 channels, a bandwidth of 11.2 Mbps is also required between the relay device 931 and the relay device 932, between the relay device 932 and the relay device 933, and between the relay device 933 and the output device 921.

However, even though the audio data of 6 channels have been transmitted from the relay device 933 to the output device 921, only one channel out of the 6 channels is actually used in the output device 921, which causes waste in the transmitted audio data.

Therefore, the relay device of the present disclosure transmits the surround audio data to a lower-side node after deleting, from the surround audio data including a plurality of audio data, audio data corresponding to an output device that is not present in the transmission destination. Thus, the bandwidth required for transmission of the surround audio data is reduced, whereby the surround audio data can be more reliably transmitted.

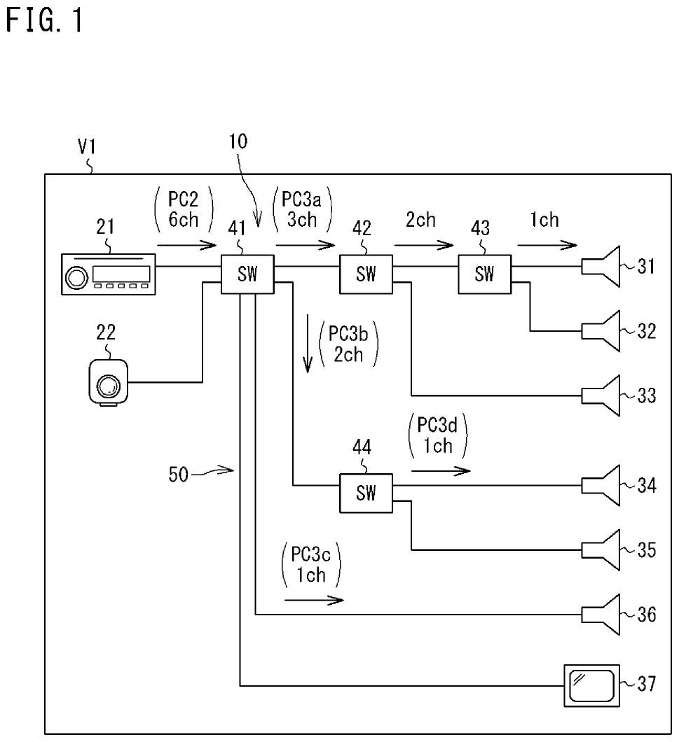

FIG. 1 is a block diagram showing the overall configuration of a relay system 10 according to the embodiment. The relay system 10 is an in-vehicle system installed in a vehicle V1 such as an automobile. The relay system 10 includes a first input device 21, a second input device 22, a plurality of first output devices 31, 32, 33, 34, 35, 36, a second output device 37, a plurality of relay devices 41, 42, 43, 44, and an Ethernet compatible communication line 50. The respective devices 21, 22, 31 to 37, and 41 to 44 are connected to each other by the communication line 50 as shown in FIG. 1, thereby constituting an in-vehicle network. The respective devices 21, 22, 31 to 37, and 41 to 44 are nodes included in the in-vehicle network.

Each of the first input device 21 and the second input device 22 is also referred to as a talker, and is capable of transmitting a packet (also referred to as a stream) based on the Ethernet AVB. Each of the first input device 21 and the second input device 22 includes a computer device (or a microcomputer device) including an arithmetic processing unit and a storage unit.

The first input device 21 is an audio data reproduction device such as a CD player or a DVD player, for example. The first input device 21 reads surround audio data including audio data of a plurality of channels from a storage medium such as a CD, for example, and transmits the surround audio data to the relay device 41.

The second input device 22 is any in-vehicle equipment other than the audio data reproduction device. The second input device 22 is, for example, an in-vehicle sensor device for detecting data related to traveling of the vehicle V1. For example, the second input device 22 is a LiDAR (light detection and ranging) device or a camera. Although one second input device 22 is provided in this embodiment, the number of second input devices 22 to be provided in the relay system 10 is not limited. For example, two or more second input devices 22 may be provided in the relay system 10. The second input device 22 need not be provided in the relay system 10.

Each of the first output devices 31, 32, 33, 34, 35, 36 and the second output device 37 is also referred to as a listener, and is capable of receiving a predetermined stream, based on the Ethernet AVB. Each of the first output devices 31, 32, 33, 34, 35, 36 and the second output device 37 includes a computer device (or a microcomputer device) including an arithmetic processing unit and a storage unit.

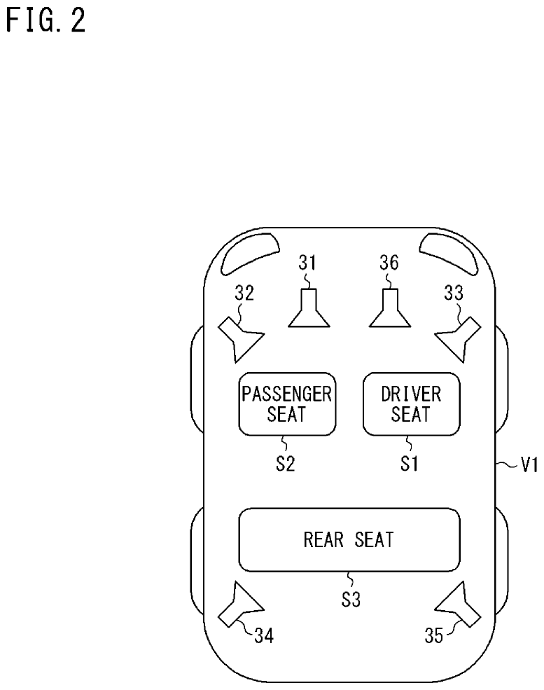

FIG. 2 is a schematic diagram illustrating an example of arrangement of the plurality of first output devices 31, 32, 33, 34, 35, 36. The first output devices 31, 32, 33, 34, 35, 36 are a set of speakers compatible with the 5.1 ch surround system, and convert the audio data transmitted from the first input device 21 into audio. The first output devices 31, 32, 33, 34, 35, 36 are arranged so as to surround a driver seat S1, a passenger seat S2, and a rear seat S3 of the vehicle V1.

More specifically, the first output device 31 is a center speaker disposed in a center position in front of the driver seat S1 and the passenger seat S2 of the vehicle V1. The first output device 32 is a left front speaker disposed on the front left side of the passenger seat S2. The first output device 33 is a right front speaker disposed on the front right side of the driver seat S1. The first output devices 34, 35 are a left rear speaker and a right rear speaker respectively disposed on the rear left side and the rear right side of the rear seat S3 of the vehicle V1. The first output device 36 is a subwoofer disposed in a center position in front of the driver seat S1 and the passenger seat S2.

In the present embodiment, six first output devices 31, 32, 33, 34, 35, 36 compatible with the 5.1 ch surround system are described as an example, but the number of the first output devices is not limited as long as it is not less than two. The number of the first output devices may be seven (e.g., compatible with the 6.1 ch surround system). Furthermore, in the present embodiment, the vehicle V1 having two rows of seats is described as an example, but the vehicle V1 may be a single-row vehicle having no rear seat S3, or may be a three-row vehicle having two rows of rear seats S3.

FIG. 1 is referred to.

The second output device 37 is any in-vehicle equipment other than a device that converts the audio data transmitted from the first input device 21 into audio. The second output device 37 is, for example, a device (e.g., a display or a speaker) that presents, to the driver, the data detected by the second input device 22. The second output device 37 may be a control device (e.g., a brake control device) that controls the vehicle V1, based on the data detected by the second input device 22. In the present embodiment, one second output device 37 is provided, but the number of second output devices 37 to be provided in the relay system 10 is not limited. For example, two or more second output devices 37 may be provided in the relay system 10. The second output device 37 need not be provided in the relay system 10.

The plurality of relay devices 41, 42, 43, 44 are devices that relay communications between the first input device 21 and the second input device 22, and the first output devices 31, 32, 33, 34, 35, 36 and the second output device 37. Each of the relay devices 41, 42, 43, 44 is also referred to as a bridge or a switch. Each of the relay devices 41, 42, 43, 44 includes a computer device (or a microcomputer device) including an arithmetic processing unit and a storage unit.

The relay device 41 is connected to the first input device 21, the second input device 22, the relay devices 42, 44, the first output device 36, and the second output device 37 via the communication line 50. The relay device 42 is connected to the relay devices 41, 43 and the first output device 33 via the communication line 50. The relay device 43 is connected to the relay device 42 and the first output devices 31, 32 via the communication line 50. The relay device 44 is connected to the relay device 41 and the first output devices 34, 35 via the communication line 50.

In the present embodiment, four relay devices 41, 42, 43, 44 are connected as shown in FIG. 1, but this is an example of the present disclosure, and another connection structure may be adopted. For example, the relay device 43 may be omitted, and the first output devices 31, 32 may be connected to the relay device 42.

Hereinafter, an upper side and a lower side of an in-vehicle network are defined based on the direction in which a packet containing a data body (e.g., the surround audio data or the data related to traveling of the vehicle V1) is transmitted. This packet is transmitted from the first input device 21, is relayed by each of the relay devices 41 to 44, and is received by each of the first output devices 31 to 36. Furthermore, this packet is transmitted from the second input device 22, is relayed by the relay device 41, and is received by the second output device 37.

Focusing on the relay device 41, the side on which the first input device 21 is present is the “upper side”, and the side on which the relay devices 42, 44, the first output device 36, and the second output device 37 are present is the “lower side”. Meanwhile, focusing on the relay device 42, the side on which the relay device 41 is present is the “upper side”, and the side on which the relay device 43 and the first output device 33 are present is the “lower side”.

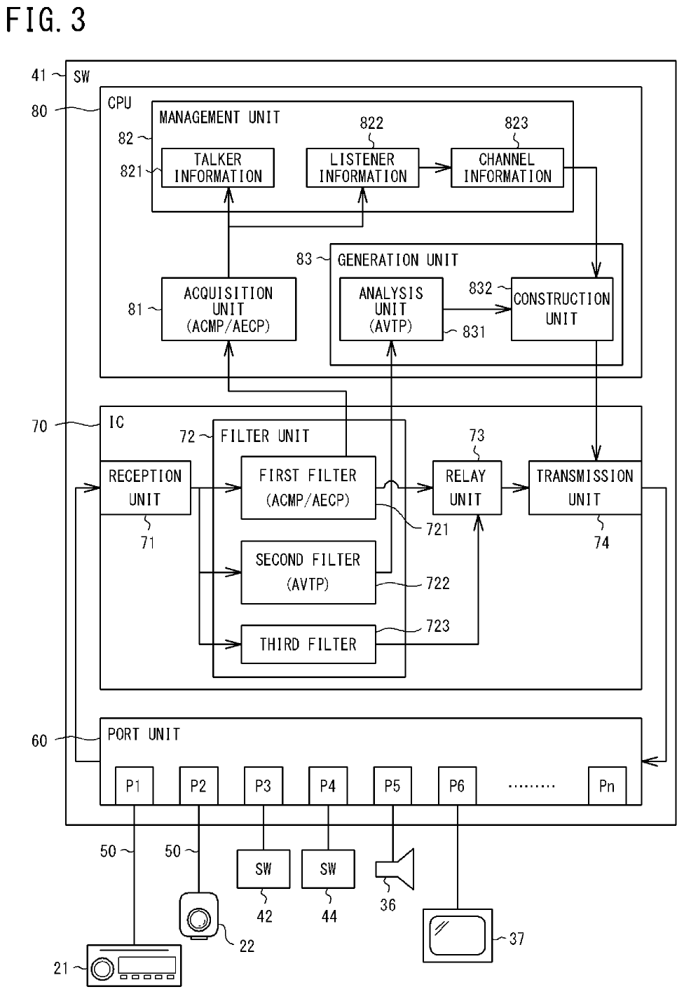

FIG. 3 is a block diagram schematically showing the functional configuration of the relay device 41.

Since the relay devices 42, 43, 44 have the same functional configuration as the relay device 41, the relay device 41 will be representatively described while omitting the description for the relay devices 42, 43, 44.

The relay device 41 includes a port unit 60, an integrated circuit 70, an arithmetic processing unit 80, and a storage unit (not shown). The port unit 60 includes a plurality of input/output ports P1, P2, P3, P4, P5, P6, . . . . Pn. The first input device 21 is connected to the port P1, the second input device 22 is connected to the port P2, the relay device 42 is connected to the port P3, the relay device 44 is connected to the port P4, the first output device 36 is connected to the port P5, and the second output device 37 is connected to the port P6. Ports P7 to Pn are free ports, for example.

Here, a port connected to a node on the upper side is referred to as “upper port” as appropriate. In the present embodiment, the ports P1, P2 are upper ports. Meanwhile, a port connected to a node on the lower side is referred to as “lower port” as appropriate. In the present embodiment, the ports P3 to P6 are lower ports. That is, the relay device 41 has a plurality of lower ports.

The in-vehicle network of the present embodiment is a tree-type network as shown in FIG. 1. For example, nodes (e.g., the relay devices 42, 43, and the first output devices 31, 32, 33) included in a first network located below the relay device 41 with a predetermined first lower port (e.g., port P3) being a starting point among the plurality of lower ports of the relay device 41, are different from nodes (e.g., the relay device 44, and the first output devices 34, 35) included in a second network located below the relay device 41 with a second lower port (e.g., the port P4) different from the first lower port being a starting point.

The integrated circuit 70 includes a reception unit 71, a filter unit 72, a relay unit 73, and a transmission unit 74. The integrated circuit 70 is an integrated circuit for switching, for example, and realizes the functions of the units 71 to 74, based on a program written therein in advance. The integrated circuit 70 may be implemented as an FPGA (Field Programmable Gate Array), for example.

The reception unit 71 receives a packet from the port unit 60, and outputs the packet to the filter unit 72. The filter unit 72 is a filter that outputs a packet to different output destinations according to the type of the packet. The filter unit 72 includes a first filter 721, a second filter 722, and a third filter 723.

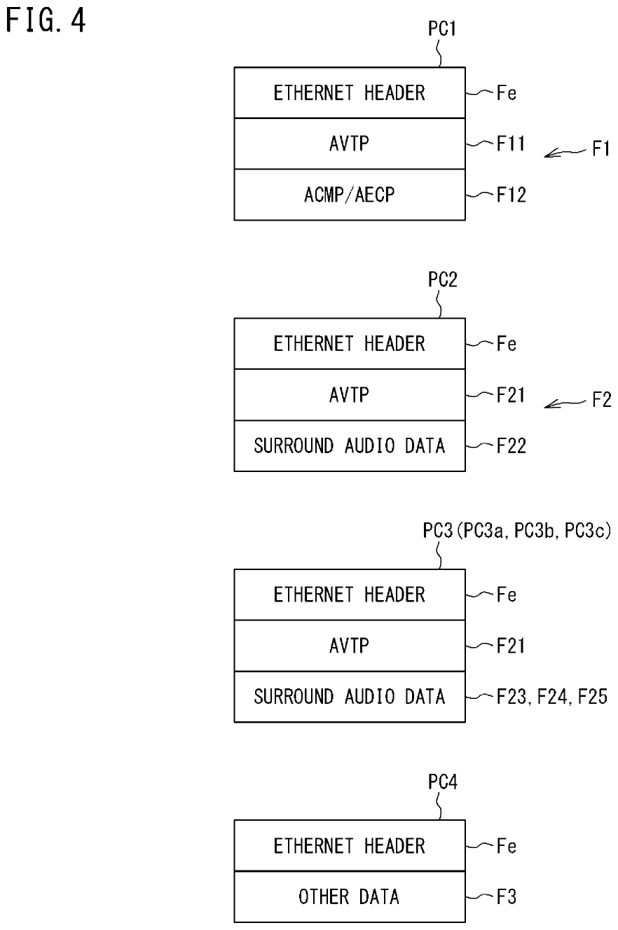

FIG. 4 shows an example of a packet configuration. In the present embodiment, packets flowing in the network include a connection packet PC1, an upper packet PC2, a lower packet PC3, and another packet PC4.

The connection packet PC1 is a packet for the talkers (devices 21, 22) to collect information about the listeners (devices 31 to 37). The connection packet PC1 includes an Ethernet header Fe and a first packet F1. The Ethernet header Fe is a header describing various kinds of information related to Ethernet communication. The first packet F1 includes a packet F11 and a packet F12. The packet F11 is a packet conforming to an AVB transport protocol (AVTP) in the IEEE1722, for example. The packet F12 is a packet conforming to a first protocol or a second protocol, and is stored in a payload of the packet F11. The first packet F1 contains various commands.

The first protocol is a protocol for managing the connection state of the various devices 21 to 22, 31 to 37, and 41 to 44 (nodes) included in the relay system 10, and is an AVDECC connection management protocol (ACMP) in the IEEE1722.1, for example.

The second protocol is a protocol for detecting the functions of the various devices 21 to 22, 31 to 37, and 41 to 44 (nodes) included in the relay system 10, and is an AVDECC enumeration and control protocol (AECP) in the IEEE1722.1, for example.

The upper packet PC2 is a packet containing surround audio data to be inputted to an upper port of a relay device (e.g., the relay device 41), and is also referred to as a stream. The upper packet PC2 includes an Ethernet header Fe, and a second packet F2. The second packet F2 includes a packet F21 describing the format of the surround audio data, and a packet F22 containing the surround audio data.

The packet F21 is, for example, a packet conforming to the AVTP, and has, stored therein, information (surround audio data format information) such as a data length (payload length) for each of samples included in the surround audio data, and the number of channels of the surround audio data.

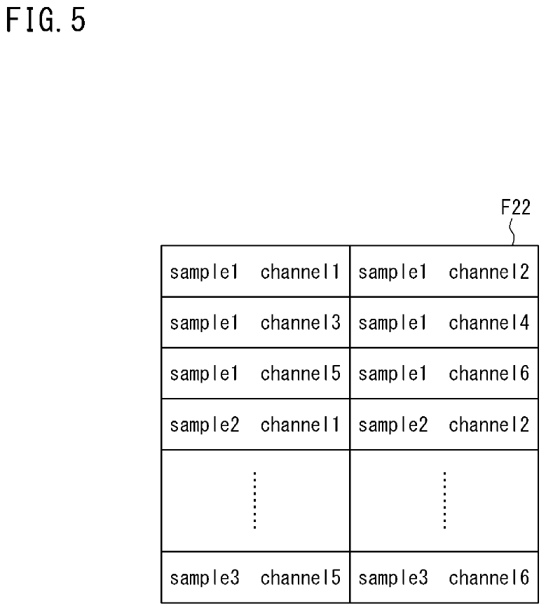

FIG. 5 shows an example of the content of the packet F22. The packet F22 is the body of the surround audio data (audio payload). The packet F22 is capsulated by using the AVTP format. In the example of FIG. 5, there are 3 samples for each of 6 channels, so that 18 samples in total are stored in the packet F22. In the present embodiment, the first output device 31 corresponds to channel number 1. Likewise, the first output devices 32 to 36 correspond to channel numbers 2 to 6, respectively.

The lower packet PC3 is a packet containing audio data of one or a plurality of channels outputted from a lower port of a relay device (e.g., the relay device 41). The lower packet PC3 will be described later.

FIG. 4 is referred to. The other packet PC4 is a packet having a role other than the roles of the connection packet PC1, the upper packet PC2, and the lower packet PC3. The packet PC4 includes an Ethernet header Fe and a third packet F3. The third packet F3 is a packet having, stored therein, data other than the data stored in the first packet F1 and the second packet F2. For example, the third packet F3 has, stored therein, a command for the talkers (devices 21, 22) to disconnect the listeners (devices 31 to 37). The third packet F3 may have, stored therein, data regarding the vehicle V1 acquired by the second input device 22. FIG. 3 is referred to.

The first filter 721 is a filter that extracts the connection packet PC1 from among the packets outputted from the reception unit 71 to the filter unit 72. The first filter 721 outputs the extracted connection packet PC1 to the relay unit 73, and duplicates the extracted connection packet PC1 and outputs the duplicate to an acquisition unit 81 described later.

The second filter 722 is a filter that extracts the upper packet PC2 from among the packets outputted from the reception unit 71 to the filter unit 72. The second filter 722 outputs the extracted upper packet PC2 to a generation unit 83 described later.

The third filter 723 is a filter that extracts the other packet PC4 from among the packets outputted from the reception unit 71 to the filter unit 72. The third filter 723 outputs the extracted other packet PC4 to the relay unit 73.

The relay unit 73 outputs the packet received from the filter unit 72 to the transmission unit 74. The relay unit 73 may output the received packet to the transmission unit 74 after subjecting the packet to various kinds of processing, or may output the received packet as it is to the transmission unit 74.

The transmission unit 74 transmits the packet received from the relay unit 73 or the arithmetic processing unit 80 to the port unit 60.

The arithmetic processing unit 80 includes an acquisition unit 81, a management unit 82, and a generation unit 83. The arithmetic processing unit 80 is implemented as a CPU, for example. The arithmetic processing unit 80 reads a computer program stored in a storage unit (not shown) and executes various kinds of arithmetic processing to realize the functions of the units 81 to 83.

Based on the connection packet PC1, the acquisition unit 81 acquires, for each of the plurality of lower ports, channel information regarding channels to be reproduced in a network located below the lower port. For example, the acquisition unit 81 extracts information regarding the talkers (devices 21, 22) and the listeners (devices 31 to 37) from the first packet F1 of the connection packet PC1. For example, the acquisition unit 81 extracts information indicating how the first output devices 31 to 36, which are the listeners to be the destinations of the surround audio data, are connected to the relay device 41, i.e., through which ports P1 to Pn. The acquisition unit 81 outputs the extracted information to the management unit 82.

The management unit 82 stores therein the information extracted by the acquisition unit 81. The management unit 82 includes a talker information storage 821, a listener information storage 822, and a channel information storage 823. The talker information storage 821 has, stored therein, information indicating a talker. If the connection packet PC1 is a packet for the first input device 21 to collect the information about the first output devices 31 to 36, information indicating the first input device 21 is stored in the talker information storage 821. The information indicating the first input device 21 includes, for example, an identification number of the first input device 21, and a port number (port P1 in this embodiment) through which the first input device 21 is connected to the relay device 41.

The listener information storage 822 has, stored therein, information indicating listeners. When the connection packet PC1 is a packet for the first input device 21 to collect information about the first output devices 31 to 36, information indicating the first output devices 31 to 36 is stored in the listener information storage 822. The information indicating the first output devices 31 to 36 include, for example, identification numbers of the first output devices 31 to 36, and port numbers through which the first output devices 31 to 36 are directly or indirectly connected to the relay device 41. The identification numbers and the port numbers are stored in association with each other.

As shown in FIG. 1, the first output device 31 is connected to the relay device 41 via the relay devices 42, 43. Therefore, the identification number of the first output device 31 is stored in the listener information storage 822 so as to be associated with the port number of the port P3 through which the relay device 42 is connected to the relay device 41. Likewise, when being stored in the listener information storage 822, the identification numbers of the first output devices 32, 33 are associated with the port number of the port P3, the identification numbers of the first output devices 34, 35 are associated with the port number of the port P4, and the identification number of the first output device 36 is associated with the port number of the port P5.

As described above, the listener information storage 822 has, stored therein, the following information in a table format, for example. The following information is an example, and the content and format of the information are not particularly limited as long as the listeners are associated with the ports P1 to Pn.
Identification number of first output device 31: port number of port P3
Identification number of first output device 32: port number of port P3
Identification number of first output device 33: port number of port P3
Identification number of first output device 34: port number of port P4
Identification number of first output device 35: port number of port P4
Identification number of first output device 36: port number of port P5

The information stored in the listener information storage 822 is outputted to the channel information storage 823.

The channel information storage 823 has, stored therein, channel information regarding a channel corresponding to each port, based on the information indicating the listeners outputted from the listener information storage 822. For example, since the first output devices 31, 32, 33 are present in the network located below the port P3, the channel information is stored in the channel information storage 823 such that the port number of the port P3 is associated with the channel numbers 1, 2, 3 to be reproduced by the first output devices 31, 32, 33. Likewise, as for the port numbers of the ports P4, P5, the channel information is stored such that the port numbers are associated with the channel numbers to be reproduced by the corresponding listeners.

As described above, the channel information storage 823 has, stored therein, channel information regarding channels to be reproduced in a lower-side network with a predetermined lower port (e.g., port P3) being a starting point. As for the channel information, port numbers and channel numbers are stored in a table format as follows, for example. The following channel information is an example, and the content and format of the channel information are not particularly limited as long as the information includes the channels corresponding to each of the ports P1 to Pn.
Port number of port P3: channel numbers 1, 2, 3
Port number of port P4: channel numbers 4, 5
Port number of port P5: channel number 6

The channel information stored in the channel information storage 823 is outputted to a construction unit 832 described later, included in the generation unit 83. The channel information storage 823 may be omitted, and the information stored in the listener information storage 822 may be directly outputted to the construction unit 832.

The generation unit 83 reconstructs the upper packet PC2 to generate a lower packet PC3 described later. The generation unit 83 includes an analysis unit 831 and a construction unit 832. The analysis unit 831 analyzes the information included in the upper packet PC2, and extracts various kinds of information from the upper packet PC2. For example, based on the surround audio data format information stored in the packet F21, the analysis unit 831 decomposes, for each channel, the surround audio data stored in the packet F22. The analysis unit 831 outputs the packet F21 and the decomposed surround audio data to the construction unit 832.

Based on the channel information, for each of the ports P1 to Pn, outputted from the channel information storage 823, the construction unit 832 deletes an unnecessary sample from the surround audio data (decomposed packet F22) outputted from the analysis unit 831, thereby reconstructing the surround audio data for each of the ports P1 to Pn.

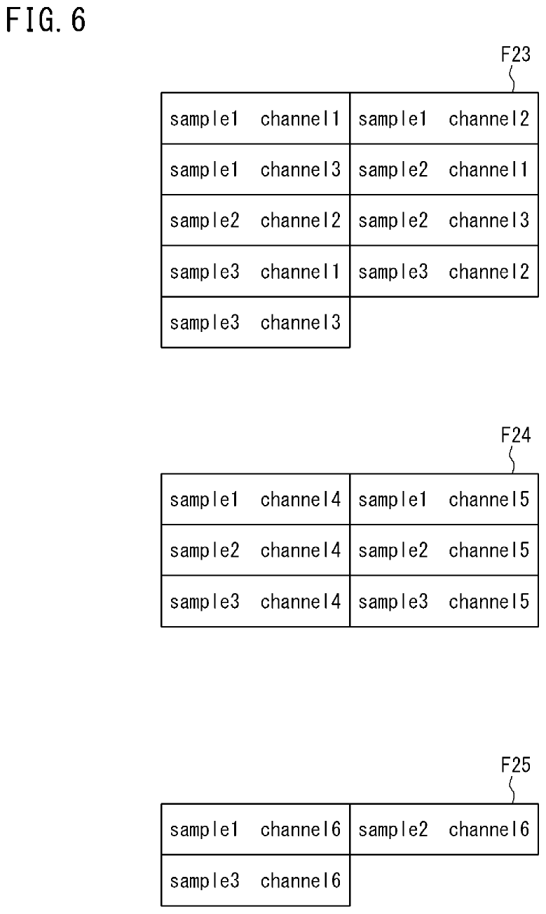

FIG. 6 shows packets F23 to F25, corresponding to the ports P3 to P5, constructed by the construction unit 832. The packets F23 to F25 are the body of the surround audio data (audio payload). The packet F23 corresponds to the port P3, the packet F24 corresponds to the port P4, and the packet F25 corresponds to the port P5.

For example, the first output devices 31, 32, 33 are present on the lower side with respect to the port P3, and the other listeners (devices 34 to 36) to be the destinations of the connection packet PC1 are not present on the lower side with respect to the port P3. Therefore, the construction unit 832 extracts only the samples with the channel numbers 1 to 3 to be reproduced by the first output devices 31, 32, 33 connected to the port P3, from the packet F22 (audio payload) shown in FIG. 5, thereby constructing the packet F23 shown in FIG. 6.

Likewise, the first output devices 34, 35 are present on the lower side with respect to the port P4, and the other listeners (devices 31 to 33, 36) to be the destinations of the connection packet PC1 are not present on the lower side with respect to the port P4. Therefore, the construction unit 832 extracts, from the packet F22, only the samples with the channel numbers 4, 5 to be reproduced by the first output devices 34, 35, thereby constructing the packet F24. Since only the first output device 36 is present on the lower side with respect to the port P5, the construction unit 832 extracts only the sample with the channel number 6 from the packet F22, thereby constructing the packet F25.

As a result, the packet F23 containing 9 samples, the packet F24 containing 6 samples, and the packet F25 containing 3 samples are constructed from the packet F22 containing 18 samples in total. Thus, based on the single packet F22, the construction unit 832 constructs a plurality of packets F23 to F25 each having samples less than the samples in the packet F22.

The construction unit 832 combines the constructed packet F23, F24, or F25 with the packet Fe and the packet F21 to generate the lower packet PC3. Hereinafter, the lower packet PC3 generated by combining the packet F23 with the packets Fe, F21 is referred to as “lower packet PC3a”. In addition, the lower packet PC3 generated by combining the packet F24 with the packets Fe, F21 is referred to as “lower packet PC3b”, and the lower packet PC3 generated by combining the packet F25 with the packets Fe, F21 is referred to as “lower packet PC3c”. The construction unit 832 outputs the generated lower packets PC3a to PC3c to the transmission unit 74.

At least a part of the function described as the integrated circuit 70 in the present embodiment may be realized by the arithmetic processing unit 80. In addition, at least a part of the function described as the arithmetic processing unit 80 may be realized by the integrated circuit 70.

Hereinafter, a relay method according to the present embodiment will be described with reference to FIG. 1 to FIG. 7 as appropriate.

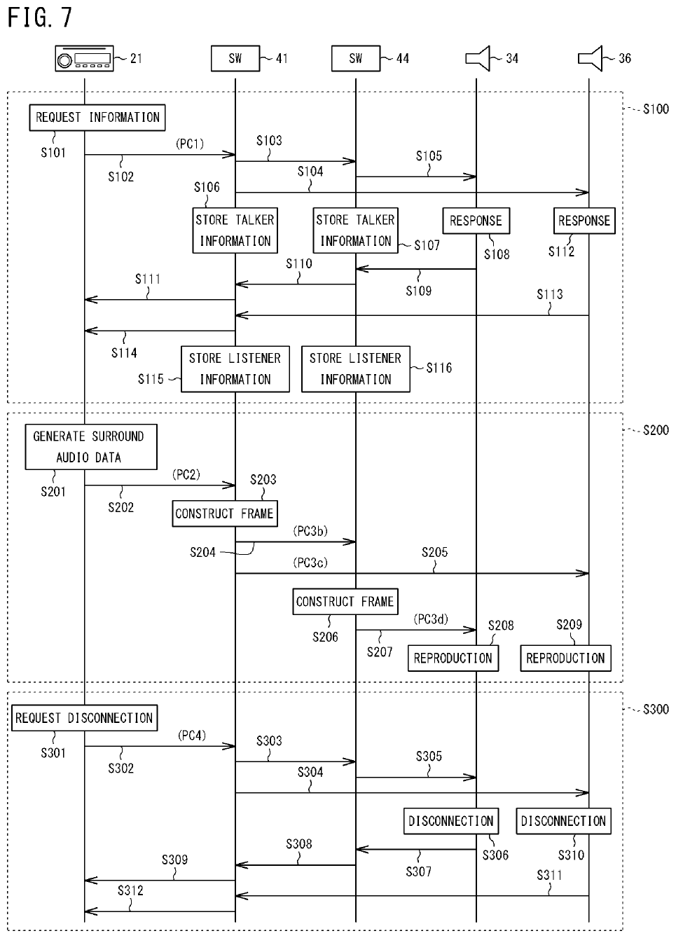

FIG. 7 is a sequence diagram showing an example of the relay method according to the present embodiment. FIG. 7 shows a representative case in which data is transmitted from the first input device 21 to the first output devices 34, 36 via the relay devices 41, 44. Since data is similarly transmitted from the first input device 21 to the other first output devices 31 to 33, 35, the description of data transmission to the first output devices 31 to 33, 35 is omitted as appropriate.

The relay system 10 of the present embodiment performs data transmission according to the Ethernet AVB including the IEEE1722. The process of data transmission is roughly divided into a connection process S100, a stream transmission process S200, and a disconnection process S300. The relay method of the present embodiment is started based on, for example, an input instruction of the user (e.g., pressing of a play button).

Each of the devices 21, 22, 31 to 37, and 41 to 44 included in the relay system 10 of the present embodiment includes a computer including a memory. An arithmetic processing unit such as a CPU in this computer reads out, from the memory, a computer program including a part or all of steps in the following flowchart and sequence, and executes the program. The computer programs for the devices 21, 22, 31 to 37, and 41 to 44 can be each installed from the outside. The computer programs for the devices 21, 22, 31 to 37, and 41 to 44 are each distributed in a state of being stored in a storage medium.

First, the connection process S100 is executed. The connection process S100 is a process of collecting information about all the listeners (devices 31 to 37) before the first input device 21 transmits the upper packet PC2 (stream), and establishing connections between the first input device 21 and the listeners. The connection process S100 is executed based on the ACMP and the AECP of the IEEE1722.1.

In the connection process S100, first, the first input device 21 generates a connection packet PC1 for requesting the information about the listeners (step S101), and transmits the connection packet PC1 to the relay device 41 (step S102). The connection packet PC1 transmitted toward the listeners is also referred to an advertisement. The relay device 41 transfers the transmitted connection packet PC1 to the relay device 44 and the first output device 36 (steps S103, S104).

Specifically, as shown in FIG. 3, in the relay device 41, the connection packet PC1 inputted to the port P1 passes through the reception unit 71, the first filter 721, the relay unit 73, and the transmission unit 74, and is outputted from the port P4 and the port P5. The connection packet PC1 outputted from the port P4 is transmitted to the relay device 44 (step S103), and the connection packet PC1 outputted from the port P5 is transmitted to the first output device 36 (step S104).

The relay device 44 transfers the transmitted connection packet PC1 to the first output device 34 (step S105). In the relay device 44, as in the relay device 41, the inputted connection packet PC1 passes through the reception unit 71, the first filter 721, the relay unit 73, and the transmission unit 74, and is outputted to the port unit 60.

Subsequently, the relay device 41 acquires information regarding the talker, based on the connection packet PC1, and stores the information in the talker information storage 821 (step S106). Specifically, the connection packet PC1 inputted to the first filter 721 in step S103 is duplicated and outputted to the acquisition unit 81. Then, in the acquisition unit 81, the information regarding the talker (e.g., the identification number of the first input device 21, and the port number of the port P1 through which the first input device 21 is connected to the relay device 41) is extracted from the connection packet PC1, and the extracted information is stored in the talker information storage 821.

The relay device 44 also acquires the information regarding the talker, based on the connection packet PC1 inputted to the first filter 721 in step S105, and stores the information in the talker information storage 821 of the relay device 44 (step S107).

Upon receiving the connection packet PC1 from the relay device 44, the first output device 34 generates a connection packet PC1 for transferring its own information to the first input device 21 (step S108), and transmits the connection packet PC1 to the relay device 44 (step S109). The connection packet PC1 transmitted to the talker is also referred to as a ready. The transmitted connection packet PC1 is transferred from the relay device 44 to the relay device 41 (step S110), and is transferred from the relay device 41 to the first input device 21 (step S111).

For example, in step S111, in the relay device 41, the connection packet PC1 inputted to the port P4 passes through the reception unit 71, the first filter 721, the relay unit 73, and the transmission unit 74, and is outputted to the port P1.

Upon receiving the connection packet PC1 from the relay device 41, the first output device 36 generates a connection packet PC1 for transferring its own information to the first input device 21 (step S112), and transmits the connection packet PC1 to the relay device 41 (step S113). The transmitted connection packet PC1 is transferred from the relay device 41 to the first input device 21 (step S114).

Subsequently, the relay device 41 acquires the information regarding the listeners, based on the connection packet PC1, and stores the information in the listener information storage 822 (step S115). Specifically, the connection packet PC1 inputted to the first filter 721 in step S111, S114 is duplicated and outputted to the acquisition unit 81. Then, in the acquisition unit 81, the information regarding the listeners (e.g., the identification numbers of the first output devices 34, 36, and the port numbers of the ports P4, P5 through which the first output devices 34, 36 are directly or indirectly connected to the relay device 41) is extracted from the connection packet PC1, and the extracted information is stored in the listener information storage 822.

The relay device 44 also acquires the information regarding the listeners, based on the connection packet PC1 inputted in step S110, and stores the information in the listener information storage 822 of the relay device 44 (step S116).

Although detailed description is omitted, since the relay device 41 is indirectly connected to the first output devices 31 to 33, 35, the relay device 41 has collected the information regarding the first output device 31 to 33, 35 in step S115, and the information is stored in the listener information storage 822. Likewise, the relay device 44 has collected the information regarding the first output device 35 in step S116, and the information is stored in the listener information storage 822.

As described above, the connection packet PC1 is transmitted/received between the first input device 21 and the first output devices 31 to 36, whereby connections between the first input device 21 and the first output devices 31 to 36 are established. This is the end of the connection process S100. Even after this, the connection process S100 is periodically repeated. Thus, the connection states between the first input device 21 and the first output devices 31 to 36 are maintained.

Subsequently, the stream transmission process S200 is executed. The stream transmission process S200 is a process in which the first input device 21 transmits the upper packet PC2. The stream transmission process S200 is executed based on the AVTP of the IEEE1722.

In the stream transmission process S200, first, the first input device 21 generates an upper packet PC2 containing surround audio data (step S201), and transmits the upper packet PC2 to the relay device 41 (step S202). The upper packet PC2 transmitted toward the listeners is also referred to as a stream.

The relay device 41 decomposes and reconstructs the upper packet PC2 received in step S202 to generate lower packets PC3a to PC3c that vary for each port as an output destination (step S203). Specifically, as shown in FIG. 3, in the relay device 41, the upper packet PC2 inputted to the port P1 passes through the reception unit 71 and the second filter 722, and is inputted to the analysis unit 831 included in the generation unit 83.

The analysis unit 831 decomposes, for each channel, the surround audio data stored in the packet F22 of the upper packet PC2, based on the surround audio data format information stored in the packet F21 of the upper packet PC2. The analysis unit 831 outputs the packet F21 and the decomposed surround audio data to the construction unit 832.

Next, based on the channel information regarding the port P4 and outputted from the channel information storage 823 (information regarding the channel to be reproduced in the network located below the port P4), the construction unit 832 deletes the samples with the channel numbers 1 to 3, 6 not included in the channel information, from the surround audio data (decomposed packet F22) outputted from the analysis unit 831, thereby constructing the packet F24 (FIG. 6) to be outputted from the port P4. Then, the construction unit 832 combines the constructed packet F24 with the packet F21 to generate a lower packet PC3b.

Likewise, based on the channel information regarding the port P5 and outputted from the channel information storage 823, the construction unit 832 deletes the samples with the channel numbers 1 to 5 from the packet F22, thereby constructing the packet F25 to be outputted from the port P5 (FIG. 6). Then, the construction unit 832 combines the constructed packet F25 with the packet F21 to generate a lower packet PC3c.

Subsequently, the relay device 41 transmits the constructed lower packet PC3b to the relay device 44 (step S204). Specifically, the lower packet PC3b is transmitted from the port P4 to the relay device 44 through the construction unit 832 and the transmission unit 74 in the relay device 41. Furthermore, the relay device 41 transmits the constructed lower packet PC3c to the first output device 36 (step S205). Specifically, the lower packet PC3c is transmitted from the port P5 to the first output device 36 through the construction unit 832 and the transmission unit 74 in the relay device 41.

The relay device 44 further decomposes and reconstructs the lower packet PC3b received in step S204 to generate a lower packet PC3d that varies for each port as an output destination (step S206). Specifically, the lower packet PC3b inputted to the relay device 44 passes through the reception unit 71 and the second filter 722 in the relay device 44, and is inputted to the analysis unit 831. The analysis unit 831 decomposes, for each channel, the surround audio data stored in the packet F22 in the lower packet PC3b, and outputs the decomposed data to the construction unit 832. Although the name of the lower packet PC3b is not changed for convenience, the lower packet PC3b is an “upper packet” inputted from the upper port when focusing on the relay device 44.

Here, only the samples with the channel numbers 4, 5 are contained in the packet F24 in the lower packet PC3b. In the construction unit 832 in the relay device 44, the sample with the channel number 5 is deleted from the packet F24, based on the channel information, for each port, outputted from the channel information storage 823. Thus, the construction unit 832 constructs a packet to be outputted to the first output device 34 (a packet containing only the sample with the channel number 4). Then, the construction unit 832 combines the constructed packet with the packet F21 to generate the lower packet PC3d.

Subsequently, the relay device 44 transmits the constructed lower packet PC3d to the first output device 34 (step S207).

Based on the lower packet PC3d received in step S207, the first output device 34 reproduces the audio data with the channel number 4 (step S208). Based on the lower packet PC3c received in step S205, the first output device 36 reproduces the audio data with the channel number 6 (step S209).

This is the end of the stream transmission process S200. Even after this, the stream transmission process S200 is periodically repeated. Thus, the upper packets PC2 containing the surround audio data are sequentially transmitted from the first input device 21, whereby reproduction of the audio data is continued in the first output devices 31 to 36.

Finally, the disconnection process S300 is executed. The disconnection process S300 is a process of disconnecting the first input device 21 from the first output devices 31 to 36. The disconnection process S300 is executed based on the ACMP of the IEEE172.1.

In the disconnection process S300, first, the first input device 21 generates a packet PC4 (FIG. 4) in which a disconnection command is included in the third packet F3 (step S301), and transmits the packet PC4 to the relay device 41 (step S302). The relay device 41 transfers the transmitted packet PC4 to the relay device 44 and the first output device 36 (steps S303, S304).

Specifically, in the relay device 41, the packet PC4 inputted to the port P1 passes through the reception unit 71, the third filter 723, the relay unit 73, and the transmission unit 74, and is outputted from the port P4 and the port P5. The packet PC4 outputted from the port P4 is transmitted to the relay device 44 (step S303), and the packet PC4 outputted from the port P5 is transmitted to the first output device 36 (step S304). The relay device 44 transfers the transmitted packet PC4 to the first output device 34 (step S305).

The first output device 34 disconnects itself from the first input device 21, based on the disconnection command included in the packet PC4, and generates a packet PC4 in which a command for notifying completion of disconnection is included in a third packet F3 (step S306). Then, the first output device 34 transmits the generated packet PC4 to the relay device 44 (step S307). Thereafter, the relay device 44 transfers the packet PC4 to the relay device 41 (step S308), and the relay device 41 transfers the packet PC4 to the first input device 21 (step S309).

Likewise, the first output device 36 disconnects itself from the first input device 21, based on the packet PC4, and generates a packet PC4 containing a command for notifying completion of disconnection (step S310). Then, the first output device 36 transmits the generated packet PC4 to the relay device 41 (step S311). Thereafter, the relay device 41 transfers the packet PC4 to the first input device 21 (step S312). This is the end of the disconnection process S300.

The relay device 41 according to the present embodiment is a relay device that relays a packet containing audio data from an upper side to a lower side of an in-vehicle network. The relay device 41 includes: the upper port P1 to which the upper packet PC2 containing audio data of a plurality of channels is inputted: the plurality of lower ports P3 to P5 that respectively output the lower packets PC3a to PC3c each containing audio data of one or a plurality of channels; and the generation unit 83 that reconstructs the upper packet PC2 to generate the lower packets PC3a to PC3c. The plurality of lower ports P3 to P5 include the first lower port (e.g., P4) and the second lower ports (e.g., P3, P5). The first lower port is a starting point of the first network located below the relay device 41, and each second lower port is a starting point of the second network that is located below the relay device 41 and does not share nodes with the first network. The generation unit 83 deletes the audio data of the channels (e.g., channel numbers 1 to 3, 6) to be reproduced in the second network, from the audio data contained in the upper packet PC2, thereby constructing the audio data to be included in the lower packet PC3b to be outputted from the first lower port.

The lower packet PC3b generated by the generation unit 83 does not contain the audio data with the channel numbers 1 to 3, 6 to be reproduced by the first output devices 31 to 33, 36 that are not present in the network located below the port P4, and therefore has a data amount smaller than that of the upper packet PC2. Therefore, the bandwidth required for transmitting the lower packet PC3b from the relay device 41 to the relay device 44 is smaller than the bandwidth required for transmitting the upper packet PC2 as it is.

For example, under a predetermined condition, if the bandwidth required for the upper packet PC2 (6 channels) is 11.2 Mbps, the bandwidth required for the lower packet PC3b (2 channels) is 6.6 Mbps, and the bandwidth required for the lower packet PC3d (1 channel) is 5.7 Mbps.

As a result, the bandwidth required for packet transmission is reduced. Thus, the bandwidth for packet transmission can be easily ensured, whereby audio data including a plurality of channels can be more reliably transmitted.

Furthermore, the generation unit 83 of the present embodiment deletes the audio data of the channels (e.g., channel number 4, 5) to be outputted in the first network, from the audio data contained in the upper packet PC2, thereby constructing the audio data to be contained in the lower packet PC3c to be outputted from the second lower port (e.g., P5).

The generation unit 83 generates the lower packets PC3a, PC3b, PC3c, each having a data amount smaller than that of the upper packet PC2, for the respective lower ports P3, P4, P5. Thus, in each of a plurality of networks located below the relay device 41, the bandwidth required for packet transmission can be reduced, whereby the audio data including a plurality of channels can be more reliably transmitted.

The relay device 41 according to the present embodiment further includes: the relay unit 73 that relays the connection packet PC1 to be transmitted from the plurality of first output devices 31 to 36 to the first input device 21 before the upper packet PC2 is inputted to the upper port P1; and the acquisition unit 81 that acquires the channel information regarding the channel to be reproduced in the network located below a predetermined lower port (e.g., port P4). The connection packet PC1 is a packet for the first input device 21 to collect information regarding the plurality of first output devices 31 to 36, and the generation unit 83 generates the lower packet PC3b, based on the channel information acquired by the acquisition unit 81.

The connection packet PC1 is a packet that is transmitted for establishing connections between the first input device 21 and the first output devices 31 to 36. Based on such an existing packet, the relay device 41 grasps the channels to be reproduced in the network located below the lower ports P3, P4, P5. Therefore, it is not necessary to increase excessive packets. That is, the audio data including a plurality of channels can be more reliably transmitted while preventing the burden of packet transmission/reception from increasing.

Moreover, the connection packet PC1 includes the packet F11 conforming to the AVDECC connection management protocol of the IEEE1722.1, and the packet F12 conforming to the AVDECC enumeration and control protocol of the IEEE1722.1. These packets F11, F12 allow the relay device 41 to easily grasp the connection states between the relay device 41 and the first output devices 31 to 36, and the channel numbers corresponding to the respective first output devices 31 to 36.

The relay device 41 according to the present embodiment further includes the filter unit 72 that outputs the connection packet PC1 inputted from each of the lower ports P3 to P5 to the relay unit 73 and the acquisition unit 81, and outputs the upper packet PC2 inputted from the upper port P1 to the generation unit 83. Further, the filter unit 72 outputs the other packet PC4 to the relay unit 73.

With the above configuration, the relay device 41 has the function of reconstructing the upper packet PC2 containing the audio data of a plurality of channels to the lower packets PC3a to PC3c, and relays the other packet PC4 as it is. Therefore, the relay device 41 can be preferably used in an in-vehicle network in which audio data and other data coexist.

Modifications Hereinafter, modifications of the present embodiment will be described. In the modifications, the same components as those of the embodiment are denoted by the same reference signs, and the description thereof is omitted.

Modification 1 of lower packet The relay device 41 of the above embodiment generates the lower packets PC3a, PC3b, PC3c for the lower ports P3, P4, P5, respectively, by deleting audio data of a predetermined channel from the upper packet PC2. However, not all the lower packets corresponding to the respective lower ports need to be generated. The upper packet PC2 may be outputted as it is, as a lower packet, from at least one lower port.

For example, the relay device 41 may output the upper packet PC2 as it is from the lower ports P4, P5 while generating the lower packet PC3a to be outputted from the lower port P3 by deleting the audio data of the channel numbers 4, 5, 6 from the upper packet PC2. Even in this configuration, the lower packet PC3a having the data amount smaller than that of the upper packet PC2 is transmitted in the network located below the lower port PC3, and therefore, reduction in the required bandwidth can be achieved.

Modification 2 of lower packet The relay device 41 of the above embodiment generates the lower packet PC3a by deleting, from the upper packet PC2, all the audio data of the channel numbers 4, 5, 6 to be reproduced in the network not located below the lower port P3. That is, the relay device 41 generates the lower packet PC3a from the upper packet PC2, while leaving only the audio data of the channel numbers 1, 2, 3 to be reproduced in the network located below the lower port P3.

However, the relay device 41 may delete, from the upper packet PC2, at least a part of the audio data of the channel numbers 4, 5, 6 to be reproduced in the network not located below the lower port P3, and may not necessarily delete all the audio data. For example, the relay device 41 may delete only the audio data of the channel number 6 from the upper packet PC2, and output the lower packet containing the audio data of the channel numbers 1 to 5 from the lower port P3.

Even in the above configuration, the lower packet has the data amount smaller than that of the upper packet PC2 because the audio data of the channel number 6 has been deleted, whereby reduction in the bandwidth required for packet transmission can be achieved. Supplementary note

At least parts of the above embodiment and the various types of modifications may be combined with each other as desired. The embodiment disclosed herein is merely illustrative and not restrictive in all aspects. The scope of the present disclosure is defined by the scope of the claims, and is intended to include meaning equivalent to the scope of the claims and all modifications within the scope.

1. A relay device that relays a packet containing audio data from an upper side to a lower side of an in-vehicle network, the relay device comprising:
an upper port configured to receive an upper packet containing audio data of a plurality of channels;
a plurality of lower ports configured to output lower packets containing audio data of one or a plurality of channels; and
a generation unit configured to reconstruct the upper packet to generate the lower packets, wherein
the plurality of lower ports include a first lower port and a second lower port,
the first lower port is a starting point of a first network that is located below the relay device,
the second lower port is a starting point of a second network that is located below the relay device and does not share nodes with the first network, and
the generation unit deletes audio data of a channel to be reproduced in the second network from the audio data contained in the upper packet, to construct audio data to be contained in the lower packet to be outputted from the first lower port.

2. The relay device according to claim 1, wherein
the generation unit deletes, from the audio data contained in the upper packet, audio data of a channel to be outputted in the first network, to construct audio data to be contained in the lower packet to be outputted from the second lower port.

3. The relay device according to claim 1, further comprising:
a relay unit configured to relay a connection packet to be transmitted from a lower-side node to an upper-side node before the upper packet is inputted to the upper port; and
an acquisition unit configured to, based on the connection packet, acquire channel information regarding a channel to be reproduced in at least one of the first network and the second network, wherein
the connection packet is a packet for the upper-side node to collect information regarding the lower-side node, and
the generation unit generates the lower packet, based on the channel information.

4. The relay device according to claim 3, wherein
the connection packet includes:
a packet conforming to an AVDECC connection management protocol in IEEE1722.1; and
a packet conforming to an AVDECC enumeration and control protocol in IEEE1722.1.

5. The relay device according to claim 3, further comprising a filter unit configured to output the connection packet inputted from the lower port, to the relay unit and the acquisition unit, and output the upper packet inputted from the upper port, to the generation unit.

6. The relay device according to claim 5, wherein
the filter unit outputs, to the relay unit, a packet other than the upper packet and the connection packet.

7. The relay device according to claim 6, wherein
data detected by an in-vehicle sensor device is contained in the packet other than the upper packet and the connection packet.

8. A relay system comprising:
the relay device according to claims;
an upper-side node configured to output the upper packet; and
a lower-side node configured to reproduce the audio data contained in the lower packet.

9. A relay method for a relay device to relay a packet containing audio data from an upper side to a lower side of an in-vehicle network,
the relay device comprising:
an upper port configured to receive an upper packet containing audio data of a plurality of channels; and
a plurality of lower ports configured to output lower packets containing audio data of one or a plurality of channels, wherein
the plurality of lower ports include a first lower port and a second lower port,
the first lower port is a starting point of a first network that is located below the relay device, and
the second lower port is a starting point of a second network that is located below the relay device and does not share nodes with the first network,
the relay method comprising a generation step of generating the lower packet by reconstructing the upper packet, wherein
the generation step includes deleting audio data of a channel to be reproduced in the second network from the audio data contained in the upper packet, to construct audio data to be contained in the lower packet to be outputted from the first lower port.

10. A computer program for a relay device to relay a packet containing audio data from an upper side to a lower side of an in-vehicle network,
the relay device comprising:
an upper port configured to receive an upper packet containing audio data of a plurality of channels; and
a plurality of lower ports configured to output lower packets containing audio data of one or a plurality of channels, wherein
the plurality of lower ports include a first lower port and a second lower port,
the first lower port is a starting point of a first network that is located below the relay device, and
the second lower port is a starting point of a second network that is located below the relay device and does not share nodes with the first network,
the computer program causing a computer to execute a generation step of generating the lower packet by reconstructing the upper packet, wherein
the generation step includes deleting audio data of a channel to be reproduced in the second network from audio data contained in the upper packet, to construct audio data to be contained in the lower packet to be outputted from the first lower port.

11. The relay device according to claim 2, further comprising:
a relay unit configured to relay a connection packet to be transmitted from a lower-side node to an upper-side node before the upper packet is inputted to the upper port; and
an acquisition unit configured to, based on the connection packet, acquire channel information regarding a channel to be reproduced in at least one of the first network and the second network, wherein
the connection packet is a packet for the upper-side node to collect information regarding the lower-side node, and
the generation unit generates the lower packet, based on the channel information.

12. The relay device according to claim 4, further comprising a filter unit configured to output the connection packet inputted from the lower port, to the relay unit and the acquisition unit, and output the upper packet inputted from the upper port, to the generation unit.

13. A relay system comprising:
the relay device according to claim 2;
an upper-side node configured to output the upper packet; and
a lower-side node configured to reproduce the audio data contained in the lower packet.

14. A relay system comprising:
the relay device according to claim 3;
an upper-side node configured to output the upper packet; and
a lower-side node configured to reproduce the audio data contained in the lower packet.

15. A relay system comprising:
the relay device according to claim 4;
an upper-side node configured to output the upper packet; and
a lower-side node configured to reproduce the audio data contained in the lower packet.

16. A relay system comprising:
the relay device according to claim 5;
an upper-side node configured to output the upper packet; and
a lower-side node configured to reproduce the audio data contained in the lower packet.

17. A relay system comprising:
the relay device according to claim 6;
an upper-side node configured to output the upper packet; and
a lower-side node configured to reproduce the audio data contained in the lower packet.

18. A relay system comprising:
the relay device according to claim 7;
an upper-side node configured to output the upper packet; and
a lower-side node configured to reproduce the audio data contained in the lower packet.
